(19) United States
(12) Patent Application Publication
(10) Pub. No.: US 2014/0357273 A1
(43) Pub. Date: Dec. 4, 2014

(54) MOBILITY CONTROL IN A COMMUNICATION SYSTEM

(71) Applicants: Yong Teng, Beijing (CN); Kari Veikko Horneman, Oulu (FI); Tao Peng, Shanghai (CN); Jiang Wang, Shanghai (CN); Jing Xu, Shanghai (CN)

(72) Inventors: Yong Teng, Beijing (CN); Kari Veikko Horneman, Oulu (FI); Tao Peng, Shanghai (CN); Jiang Wang, Shanghai (CN); Jing Xu, Shanghai (CN)

(73) Assignee: NOKIA SOLUTIONS AND NETWORKS OY, Espoo (FI)

(21) Appl. No.: 14/371,859

(22) PCT Filed: Jan. 20, 2012
(86) PCT No.: PCT/CN2012/070682

§ 371 Date: Jul. 11, 2014

(51) Int. Cl. H04W 8/02; H04W 36/32

(52) U.S. Cl. CPC H04W 8/02; H04W 36/32
USPC 455/436

(57) ABSTRACT

The disclosure relates to generation of mobility information. A mobile device can determine, based on measurements, at least one parameter relating to its movement relative to a cell. A weighting of a counter output for use in estimation of a mobility state of the mobile device is determined. The determining includes comparison of the at least one parameter to at least one threshold. Information about the weighting can be provided by a network element. When the network element obtains the weighted estimation it can take it into account in mobility control of the mobile device.

### TECHNICAL FIELD

The application relates to mobile communications and more particularly to mobility control in a mobile communication system.

### BACKGROUND

A communication system can be seen as a facility that enables communication sessions between two or more nodes such as fixed or mobile communication devices, access points such as base stations, servers and so on. A communication system and compatible communicating devices typically operate in accordance with a given standard or specification which sets out what the various entities associated with the system are permitted to do and how that should be achieved. For example, the standards, specifications and related protocols can define the manner how and what communication devices shall communicate with the access points, how various aspects of the communications shall be implemented and how the devices shall be configured.

Signals can be carried on wired or wireless carriers. Examples of wireless systems include public land mobile networks (PLMN) such as cellular networks, satellite based communication systems and different wireless local networks, for example wireless local area networks (WLAN). Wireless systems can be divided into coverage areas referred to as cells. Different types of cells can provide different features. For example, cells can have different shapes, sizes, power levels and other characteristics.

A user can access the communication system by means of an appropriate communication device. A communication device of a user is often referred to as user equipment (UE) or terminal. A communication device is provided with an appropriate signal receiving and transmitting arrangement for enabling communications with other parties. Wireless systems enable mobility for users where a mobile device can communicate over an air interface with another communication device such as e.g. a base station and/or other user equipment.

A mobile communication system may be based on an architecture standardized by the 3rd Generation Partnership Project (3GPP). A development based on this architecture is often referred to as the long-term evolution (LTE) of the Universal Mobile Telecommunications System (UMTS) radio-access technology and the recent development is referred to as LTE advanced. In LTE base stations are commonly referred to as enhanced NodeBs (eNB). In LTE a node providing a relatively wide coverage area is referred to as a macro eNode B. Network nodes can also provide smaller service areas. Examples of such smaller or local radio service area network nodes include femto nodes such as Home eNBs (HeNB), pico nodes such as pico eNodeBs (pico-eNB), micro nodes and remote radio heads. A smaller radio service area can be located wholly or partially within one or more larger radio service areas. Different radio technologies may be used at the same time in a multi-layered system. Multi-layered systems are often referred to as heterogeneous networks or HetNets. An example of a multi-layered system is a mixture of macro base stations and small power base stations (e.g. pico and micro stations). The various layers can be deployed as part of a cellular network. It is noted that a multi-layer LTE network is used herein only as an example of multi-layered systems and that other solutions are also possible.

Mobility can be provided between the cells. This can be provided by selection of a cell to be used instead of the current cell and handover of the device from the current cell to the selected new cell. In heterogeneous cellular systems the handover may also occur between the different layers. Mobility Management (MM) can impact user experience, mobile power consumption and load reduction of network signaling, in particular in connection with heterogeneous networks.

In the context of terms cell selection and cell reselection it is noted that although for example in 3GPP cell selection and reselection are understood as being somewhat different processes, both of these terms can in general be understood to refer to a process where a cell is selected based on a criterion. Thus, although in the specific terminology of the 3GPP cell selection is used in the context where cell selection is required on transition from mobility management detached state to registered state, or recovery from out of coverage and cell reselection is used when UE is a cell is selected for handover, i.e. a UE first performs a cell selection and then later on a cell reselection in handover, in general both of these operations involve selection of a cell. Therefore, in this description both terms selection and reselection shall be understood generally to mean an operation where a cell is selected by a mobile device.

Mobility information, such as information about the velocity of a mobile user can be used for efficient resource management and/or quality of service provision in systems such as the LTE. Information about the velocity can be defined by means of parameter known as mobility state. Mobility state information can be used for setting of mobility parameters and also for mobility robustness optimization. The knowledge of the mobility state can be used for example to assign a slow moving device to HeNB/pico cell and a fast moving device to macro cells. An estimate of mobility state level can be provided. The mobility state estimation is typically based on predefined estimation criteria. It may not be easy to provide accurate velocity information in all circumstances.

Three different mobility states are defined in LTE: normal, medium and high. In LTE radio resource control idle (RRC_IDLE) mode these states are separated based on number of cell reselections occurring over a predefined time window. In RRC connected (RRC_CONNECTED) mode, the separation is based on number of handovers. The state can be determined based on predefined criteria using predefined thresholds NCR_H (Threshold for differentiating Medium and High mobility state) and NCR_M (Threshold for differentiating Normal and Medium mobility state):
Medium-mobility state is determined if the number of cell reselections during time period TCRMAX exceeds NCR_M and does not exceed NCR_H; and
High-mobility state is determined if the number of cell reselections during time period TCRMAX exceeds NCR_H.

In HetNet scenarios cell sizes can vary significantly. As a consequence mobility state estimation can become more complicated.

The current methods may not always be accurate enough to estimate the mobility state of a device in all occasions. For example, the following two different movement scenarios are possible. A mobile device can reselect a cell and thereafter leave the cell soon from the edge. According to another scenario a mobile device can reselect a cell, move cross the cell substantially through the middle thereof, and then leave the cell. A reselection counter will increase by one in both of these scenarios. However, the significance of the increment is totally different, as the device in the latter scenario may be moving faster that the device in the first, and yet may stay longer on the cell. Use of such information may lead to poor accuracy while estimating mobility state of a mobile device, for example in estimation whether the state is medium or high speed. For example, when a mobile device speeds up from a normal mobility state to medium mobility state, mobility parameters such as Treselection (RRC_IDLE mode), TimeToTrigger (RRC_CONNECTED MODE), and Qhyst are scaled according to the mobility state. Poor accuracy of mobility state estimation and the resulting inaccurate scaling may lead to problems such as serious radio link failure (RLF).

It is noted that the above discussed issues are not limited to any particular communication environment and station apparatus but may occur in any appropriate system where cells are selected by mobile devices.

### SUMMARY

Embodiments of the invention aim to address one or several of the above issues.

In accordance with an embodiment there is provided a method for providing mobility information for a mobile device, comprising determining, based on measurements by the mobile device, at least one parameter relating to movement of the mobile device relative to a cell, and determining weighting of counter output associated for use in estimation of a mobility state of the mobile device, the determining comprising comparison of the at least one parameter to at least one threshold.

In accordance with another embodiment there is provided a method for mobility control, comprising providing information about weighting of a counter output for use in estimation of a mobility state of a mobile device, the information comprising at least one threshold, obtaining information of estimated mobility state of the mobile device, the information being based on at least one parameter determined based on measurements by the mobile device and the at least one threshold, and taking the information of the estimated mobility state into account in mobility control of the mobile device.

In accordance with another embodiment there is provided an apparatus for mobility control of a mobile device, the apparatus comprising at least one processor, and at least one memory including computer program code, wherein the at least one memory and the computer program code are configured, with the at least one processor, to determine, based on measurements by the mobile device, at least one parameter relating to movement of the mobile device relative to a cell, and to determine weighting of counter output for use in estimation of a mobility state of the mobile device, the determining comprising comparison of the at least one parameter to at least one threshold.

In accordance with a yet another embodiment there is provided an apparatus for mobility control, the apparatus comprising at least one processor, and at least one memory including computer program code, wherein the at least one memory and the computer program code are configured, with the at least one processor, to provide information about weighting of a counter output for use in estimation of a mobility state of a mobile device, the information comprising at least one threshold, to obtain information of estimated mobility state of the mobile device, the information being based on at least one parameter determined based on measurements by the mobile device and the at least one threshold, and to take the information of the estimated mobility state into account in mobility control of the mobile device.

In accordance with a more specific embodiment the weighting is based on selection of a weight from a set of weights based on the at least one threshold.

Information about the at least one threshold and/or the at least one predefined weight for selection may be communicated to the mobile device. The mobile device may be provided with information about at least one weight parameter and the at least one threshold by means of broadcasted system information element. The broadcast may be by a serving cell. The information about the at least one threshold may comprise a set of thresholds and/or the at least one predefined weight may comprise a set of predefined weights

Different cells may be provided with a different at least one threshold and/or a different at least one predefined weight. The different cells may belong to a heterogeneous network.

The measurements may comprise measurement of at least one of signal power, signal quality and error rate.

The at least one parameter may be determined based on difference between measured values of a parameter monitored by the mobile device. For example, a difference between a maximum and minimum value may be determined.

The weighting may be applied to reselection count or handover count.

A mobility state may be categorised based on a weighted counter output. A computer program comprising program code means adapted to perform the herein described methods may also be provided. In accordance with further embodiments apparatus and/or computer program product that can be embodied on a computer readable medium for providing at least one of the above methods is provided.

A node such as a network control element or a mobile device can be configured to operate in accordance with the various embodiments.

It should be appreciated that any feature of any aspect may be combined with any other feature of any other aspect.

### BRIEF DESCRIPTION OF THE DRAWINGS

Embodiments will now be described in further detail, by way of example only, with reference to the following examples and accompanying drawings, in which:

FIG. 1 shows a schematic diagram of a network according to some embodiments;

FIG. 2 shows a schematic diagram of a mobile communication device according to some embodiments;

FIG. 3 shows a schematic diagram of a control apparatus according to some embodiments;

FIGS. 4 and 5 show flowcharts according to certain embodiments; and

FIG. 6 shows schematic examples how a mobile device may move relative to a cell.

### DETAILED DESCRIPTION OF THE DRAWINGS

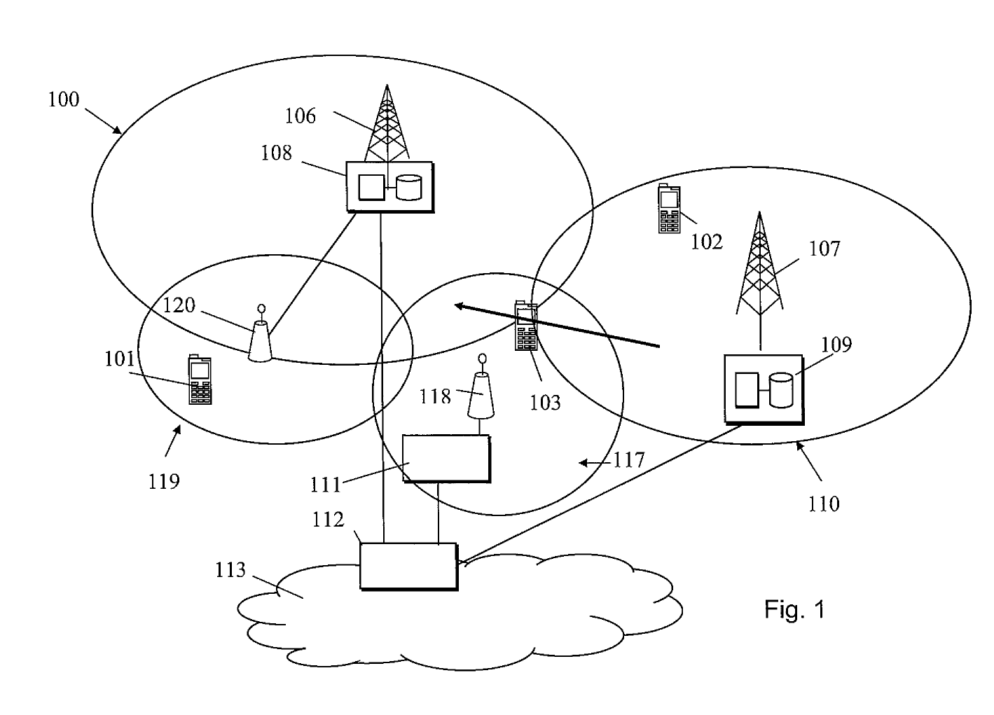

In the following certain exemplifying embodiments are explained with reference to a wireless or mobile communication system serving mobile communication devices. Before explaining in detail the exemplifying embodiments, certain general principles of a mobile communication system, access systems thereof, and mobile devices are briefly explained with reference to FIGS. 1 to 3 to assist in understanding the technology underlying the described examples.

A non-limiting example of the recent developments in communication system architectures is the long-term evolution (LTE) of the Universal Mobile Telecommunications System (UMTS) standardized by the 3rd Generation Partnership Project (3GPP). More recent development of the LTE are sometimes referred to as LTE-Advanced. The LTE employs a mobile architecture known as the Evolved Universal Terrestrial Radio Access Network (E-UTRAN). Base stations of such systems are known as evolved or enhanced Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access).

A mobile communication device 101, 102, 103 can be provided wireless access via base stations or similar wireless transmitter and/or receiver nodes providing radio service areas or cells. In FIG. 1 four different neighbouring radio service areas are cells 100, 110, 117 and 119 are shown being provided by base stations 106, 107, 118 and 120. It is noted that the number of cells and the cell borders are only schematically shown for illustration purposes in FIG. 1, and that these can vary considerably from that shown. It shall be understood that the sizes and shapes of the cells may vary considerably from those shown in FIG. 1.

Base stations are typically controlled by at least one appropriate controller apparatus so as to enable operation thereof and management of mobile communication devices in communication with the base stations. The control apparatus can be interconnected with other control entities. The control apparatus can typically be provided with memory capacity and at least one data processor. The control apparatus and functions may be distributed between a plurality of control units. In some embodiments, each base station can comprise a control apparatus. In alternative embodiments, two or more base stations may share a control apparatus.

Different types of possible cells include those known as macro cells, pica cells, micro cells and femto cells. For example, in LTE-Advanced the transmission/reception points or base stations can comprise wide area network nodes such as a macro eNode B (eNB) which may, for example, provide coverage for an entire cell or similar radio service area. Base station can also be provided by small or local radio service area network nodes, for example Home eNBs (HeNB), pico eNodeBs (pico-eNB), or femto nodes. Some applications utilise radio remote heads (RRH) that are connected to for example an eNB. A mobile communication device may be located in the service area of different cell, communicate with more than one cell and be handed over from a cell to another.

In particular, FIG. 1 depicts two macro cells 100 and 110 provided by wide area base stations 106 and 107. A smaller cell 117 in this example can be a pica-cell or a femto cell. A yet further cell 119 is shown to be provided by a remote radio head (RRH) 120 connected to the base station apparatus of cell 100. Base station nodes may communicate via each other via fixed line connection and/or air interface. The logical connection between the base station nodes can be provided for example by an X2 interface.

In FIG. 1 the macro base stations are shown as connected to a wider communications network 113 via gateway 112. A further gateway function may be provided to connect to another network. The smaller stations 118 and 120 can also be connected to the network 113, for example by a separate gateway function and/or via the macro level cells. In the example, station 118 is connected via a gateway 111 whilst station 120 connects via the controller apparatus 108.

In FIG. 1 mobile device 103 is shown to be moving in direction from cell 110 over cell 117 towards cell 100, see the arrow.

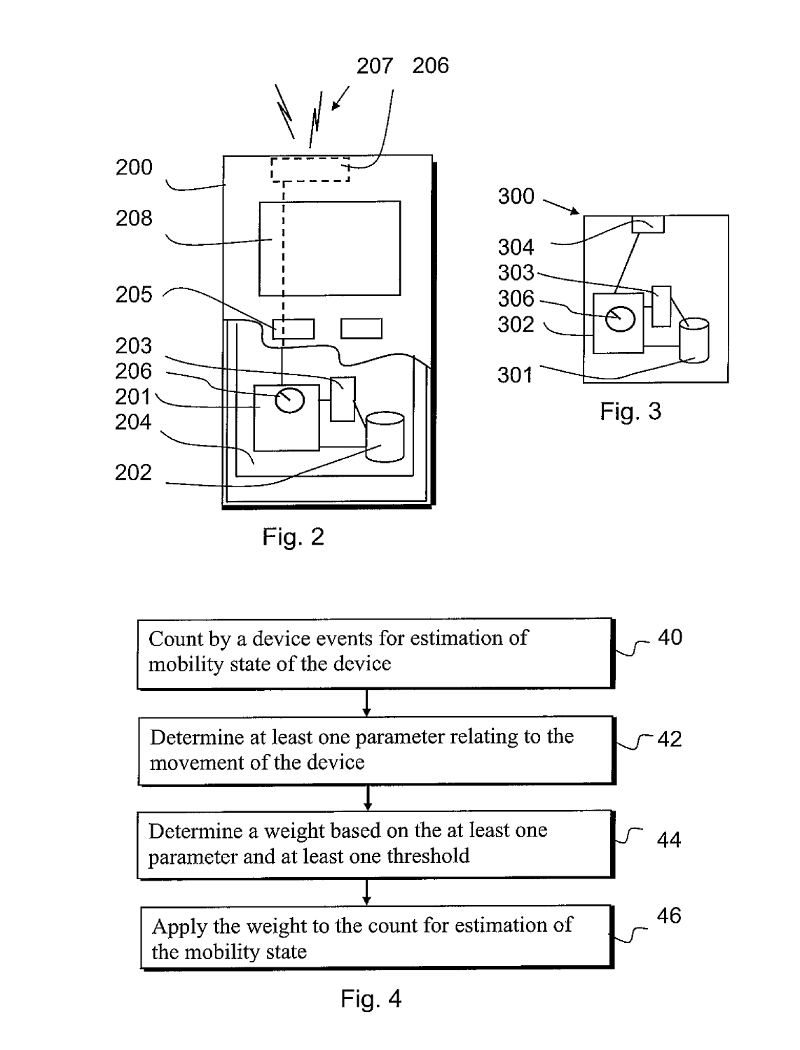

A possible mobile device for communications with the base stations will now be described in more detail with reference to FIG. 2 showing a schematic, partially sectioned view of a mobile device 200. Such a device is often referred to as user equipment (UE) or terminal. An appropriate mobile device may be provided by any device capable of sending radio signals to and/or receiving radio signals from multiple cells. Non-limiting examples include a mobile station (MS) such as a mobile phone or what is known as a ‘smart phone’, a portable computer provided with a wireless interface card or other wireless interface facility, personal data assistant (FDA) provided with wireless communication capabilities, or any combinations of these or the like. A mobile device may provide, for example, communication of data for carrying communications such as voice, electronic mail (email), text message, multimedia and so on. Users may thus be offered and provided numerous services via their devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information.

The mobile device may receive and transmit signals over an air interface 207 with multiple base stations via an appropriate transceiver apparatus. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is also provided with at least one data processing entity 201, at least one memory 202, at least one timer 206 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204.

The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus for a communication system, for example to be coupled to and/or for controlling a transceiver base station. The control apparatus 300 can be arranged to provide control on communications in the service area of a cell. In some embodiments a base station can comprise a separate control apparatus. In other embodiments the control apparatus can be another network element. The control apparatus 300 can be configured to provide control functions in association with generation and communication of information of cells and/or control functions based on such information by means of the data processing facility in accordance with certain embodiments described below. For this purpose the control apparatus comprises at least one memory 301, at least one data processing unit 302, 303 and an input/output interface 304. At least one timer function 306 may also be provided. Via the interface the control apparatus can be coupled to a receiver and a transmitter of the base station. The control apparatus can be configured to execute an appropriate software code to provide the control functions.

A wireless communication device, such as a mobile or base station, can be provided with a Multiple Input/Multiple Output (MIMO) antenna system for enabling multi-flow communications. MIMO arrangements as such are known. MIMO systems use multiple antennas at the transmitter and receiver along with advanced digital signal processing to improve link quality and capacity. More data can be received and/or sent where there are more antennae elements.

In accordance with an embodiment shown by the flowchart of FIG. 4 mobility state of a mobile device moving relative to a cell can be estimated based on weighting of at least one parameter used in estimation of the mobility state. The weighting can be based on measurements by the mobile device and information provided by the network. Other information, for example cell characteristics, may also be taken into account. More particularly, according to FIG. 4 an event such as cell reselection or handover may take place at 40 based on measurements by the mobile device. For example, the mobile device may measure properties of the received signal signals such as power, quality and/or error rate. The mobile device can then determine at 42, based on the measurements, at least one parameter that relates to the way the mobile device moves relative to the cell. A weighting can be determined at 44 for use in estimation of a mobility state for the mobile device. The determination can be provided based on comparison of the at least one parameter to at least one threshold, where the threshold is used to define at least two different weights. The weighting can be used to influence the output of the cell reselection counter so that information about the movement of the device in the cell can be taken into account in estimation of the mobility state at 46.

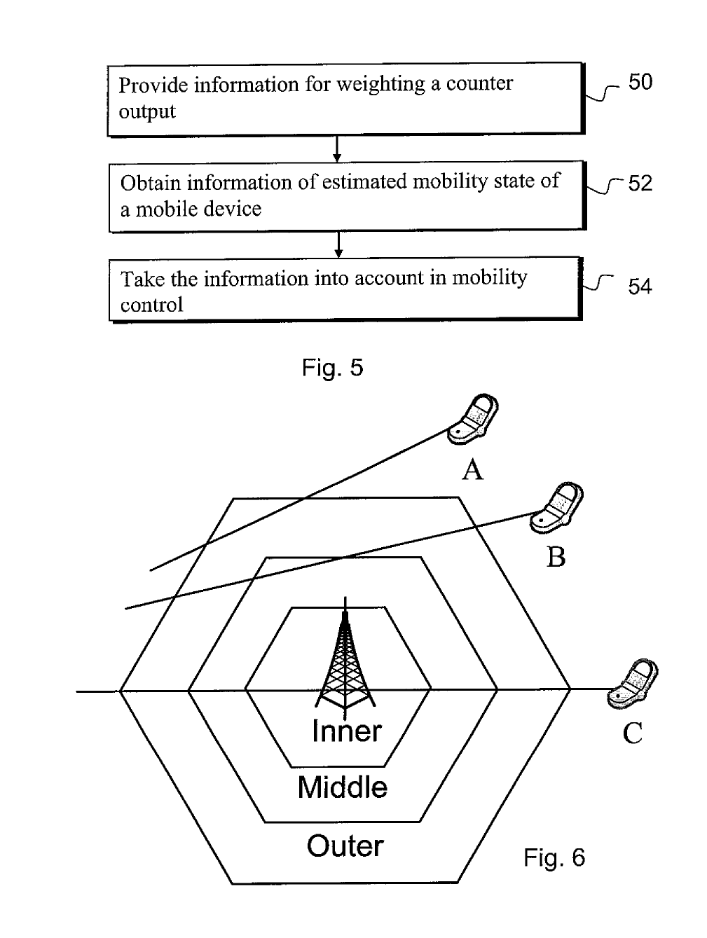

FIG. 5 illustrates possible operation at a node, for example at a network element. The network element can provide information at 50 about weighting of a counter output for use in estimation of a mobility state of a mobile device. This may be transmitted e.g. in system information. The information can comprise at least one threshold and may also comprise other information. As explained above, the weighting can be based on the at least one parameter determined based on measurements and the at least one threshold. Information about estimated mobility state of the mobile device can then be obtained, e.g. received or determined at the node, at 52. The information can then be taken into account at 54 in mobility control.

The information of the estimated mobility state may be obtained be an output of the counter, or the mobility state (e.g. high-mobility state, medium-mobility state, or normal-mobility state), or any other form of information reflecting the mobility state.

Estimation of the mobility state can be done e.g. at eNodeB (eNB) and/or at a mobile device. The information may be used by a network element such as the eNB and/or the mobile device.

A mobile device can be provided with a counter for counting events such as cell reselections and/or handovers. This functionality can be provided e.g. by the processor component 203 of FIG. 2. Mobility state estimation can be provided at the mobile device based on the counter output that is weighted based on the weighting and information of the weighted estimation of mobility state can be sent to the network. The mobility estimate can be used in the network side by an appropriate control apparatus to control reselection and handover rates. The network can use the estimate to set parameters such as Treselection and Qhyst, and handover parameters such as TimeToTrigger.

A control apparatus in the network can set the parameters needed in the mobility estimation. For example, the parameters can be broadcast in the system information of the serving cell. The mobile device can then use these parameters and the counted number of cell reselection/handover to estimate the mobility state. For medium and high mobility states in Idle mode, the mobile device can add an offset to the signalled (e.g. Qhyst; a cell reselection margin) and scale the Treselection by a factor given by the mobility state. In Connected mode, UE scales TimetoTrigger by a factor. These scaling factor parameters are also signalled by the network.

The information needed for weighting can be communicated from a network element, e.g. a eNB to a mobile device. In accordance with an embodiment information elements for a weight value and a threshold can be added into information associated with the mobility state parameters. The network can broadcast the weighting parameters via system information. For example, LTE System Information Block Type3 can be extended to include appropriate parameters. For convenience, such parameters are called below ‘CellCrossingWeight’ and ‘CellCrossingThreshold’. Information element ‘mobilityStateParameters’ in accordance with 3GPP document “Evolved Universal Terrestrial Radio Access (E-UTRA) Radio Resource Control (RRC) Protocol specification” TS 36.331 version 10.1.0 of March 2011, paragraph 6.3.4 “Mobility control information elements” can then be:

| | | |
|---|---|---|
| t-Evaluation | t-HystNormal | n-CellChangeMedium |
| n-CellChangeHigh | CellCrossingWeight | CellCrossingThreshold |

In accordance with this embodiment CellCrossingThreshold parameter is used to define how a mobile device is crossing a cell.

The parameter defining the movement of a device relative to a cell can be provided as a set of thresholds. For example, a set of parameters {CellCrossingThreshold1, CellCrossingThreshold2} may be provided.

Parameter such as the CellCrossingWeight can be used for cell reselection/handover counting. The weight parameter can be given as a set of weights, for example as {CellCrossingWeight1, CellCrossingWeight2, CellCrossingWeight3}. Each weight of the set can correspond to a different cell crossing route.

In accordance with an embodiment a mobility state estimation method is provided where factors such as how a mobile device crosses a cell and characteristics of a heterogeneous network (HetNet) are considered. In a HetNet scenario different value sets for CellCrossingWeight and/or CellCrossingThreshold parameters can be used for different types of cells. For example, different sets can be used for macro, pico, micro or home cells and so on.

A mobile device can use appropriate measurement results to determine an appropriate weight from a set of weight parameters. For example, a mobile device can measure Reference Signal Receiving Power (RSRP) and Reference Signal Receiving Quality (RSRQ) levels of the serving cell for every discontinuous reception (DRX) cycle. Difference between maximum and minimum RSRP and/or RSRQ can be used in determining an estimate how the mobile device crosses the cell. A cell-crossing parameter R for the serving cell can be defined e.g. by:

R=RSRP_MAX−RSRP_MIN (1)

A weight parameter can be assigned with a different value according to the relationship between the cell-crossing parameter R and a cell crossing threshold value. An example of this will be given

Different types of cells in a HetNet scenario can be reflected by a range of cell-crossing parameters R.

For every reselection/handover, the counter output is additionally increased by the determined weight parameter as shown by:

Nₜₒₜₐₗⁿ⁺¹=Nₜₒₜₐₗⁿ+Weight (2)

In accordance with a more detailed exemplifying embodiment a cell over which a mobile device moves can be divided into three parts: outer, middle and inner part, see FIG. 6. Three different paths of movement of the device, A, B and C, are shown. Cell crossing parameter R is counted by equation (1). A weight can then be determined based on this parameter such that if

a) R<
CellCrossingThreshold1
=>Weight=CellCrossingWeight1;

b) CellCrossing
Threshold1<R<CellCrossingThreshold2
=>Weight=CellCrossingWeight2; or

c) R>
CellCrossingThreshold2
=>Weight=CellCrossingWeight3;

The above described algorithm can be applied to mobile devices (UEs) in idle mode in the following manner:

1) While moving, UEs perform cell reselection measurements and possible cell reselection(s). The measured quantity used for the reselection evaluation can be e.g. RSRP. An UE measures the RSRP of a serving cell, and compares the measured RSRP value with MIN and MAX thereof. If the measured RSRP<MIN, MIN is replaced by the measured RSRP. If the measured RSRP>MAX, MAX is replaced by the measured RSRP. This is repeated until a reselection occurs.

2) When reselection occurs, the UE computes parameter R by Equation (1). Weight is assigned with different value according to computed parameter R. If the UE reselects to a cell and leaves the cell soon from the edge (see path A in FIG. 6 and option a) above), then R is relatively small and the weight can be assigned with CellCrossingWeight1; If the UE crosses the cell from the middle (see path C and option c)), then R is relatively high and weight can be assigned with CellCrossingWeight3. The UE can then increase the counter by the weight according to (2):

Nₜₒₜₐₗⁿ⁺¹=Nₜₒₜₐₗⁿ+Weight

3) If a predefined time expires (T>=T_{CRMAX}), Nₜₒₜₐₗ is compared with predefined thresholds to obtain the mobility state. For example, the following rule can be used:

Nₜₒₜₐₗ>N_{CR}_{_{—}}_{H}=> mobility state of UE is classified as high;

N_{CR}_{_{—}}_{M}<Nₜₒₜₐₗ<N_{CR}_{_{—}}_{H}=> mobility state of UE is classified as medium;

Nₜₒₜₐₗ<N_{CR}_{_{—}}_{M}=> mobility state of UE is classified as normal.

If the time has not yet expired, the algorithm can revert to step 1.

4) One estimation period is over when the time expires. Mobility parameters can be scaled according to the mobility state estimated at 3). At this stage the counter can be reset and MAX and MIN to reset to zero, and the algorithm restarted from step 1.

The proposed method can also be used in RRC connected mode. In connected mode the network typically makes the final handover decision based on measurements by a mobile device whereas in the idle mode the mobile device can decide when to perform a reselection using the parameters set by the network. Nevertheless, a mobile device in the connected mode can scale its mobility parameters according to mobility state and perform the measurements. The weighted mobility state information can then be used in mobility management operations. An appropriate counter may count events such as cell reselection in the idle mode and handovers in the connected mode.

Instead of providing the estimated mobility state based on the weighting by a mobile device, this may also take place elsewhere. For example, the weighting may be applied at a control apparatus in a network. The weight may be applied either to an estimate by the mobile device, or the estimation itself may be provided at the network.

The above described embodiments may provide several advantages. In particular, taking the manner how a mobile device crosses a cell into account estimation accuracy can be improved. This can be particularly the case with medium and high speed mobility states. Because existing measurements by a communication device can be utilised complexity is not increased and any additional signalling overhead can be kept low.

It is noted that whilst embodiments have been described using LTE and LTE Advanced as examples, similar principles can be applied to any other communication system or indeed to further developments with LTE. Thus, instead of LTE, the invention may be applied to other cellular standards as well. Different layers may be implemented in different radio access technology (RAT), for example such that a GSM macro layer and LTE micro layer is provided. Also, instead of carriers provided by base stations at least one of the carriers may be provided by a communication device such as a mobile user equipment. For example, this may be the case in application where no fixed equipment provided but a communication system is provided by means of a plurality of user equipment, for example in adhoc networks. Therefore, although certain embodiments were described above by way of example with reference to certain exemplifying architectures for wireless networks, technologies and standards, embodiments may be applied to any other suitable forms of communication systems than those illustrated and described herein.

The required data processing apparatus and functions of a base station apparatus, a communication device and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims. Indeed there is a further embodiment comprising a combination of one or more of any of the other embodiments previously discussed.

1. A method for providing mobility information for a mobile device, comprising
determining, based on measurements by the mobile device, at least one parameter relating to movement of the mobile device relative to a cell, and
determining weighting of counter output for use in estimation of a mobility state of the mobile device, the determining comprising comparison of the at least one parameter to at least one threshold.

2. A method for mobility control, comprising
providing information about weighting of a counter output for use in estimation of a mobility state of a mobile device, the information comprising at least one threshold,
obtaining information of estimated mobility state of the mobile device, the information being based on at least one parameter determined based on measurements by the mobile device and the at least one threshold, and
taking the information of the estimated mobility state into account in mobility control of the mobile device.

3. (canceled)

4. (canceled)

5. (canceled)

6. (canceled)

7. A method according to claim 1, wherein different cells are provided with a different at least one threshold and/or a different at least one predefined weight.

8. (canceled)

9. A method according to claim 1, wherein the measurements comprise measurement of at least one of signal power, signal quality and error rate.

10. A method according to claim 1, wherein the at least one parameter is determined by computing the difference between measured values of a parameter monitored by the mobile device.

11. A method according to claim 1, comprising weighting a reselection count or handover count.

12. A method according to claim 1, comprising categorising mobility state of the mobile device based on a weighted counter output.

13. (canceled)

14. An apparatus for mobility control of a mobile device, the apparatus comprising at least one processor, and at least one memory including computer program code, wherein the at least one memory and the computer program code are configured, with the at least one processor, to
determine, based on measurements by the mobile device, at least one parameter relating to movement of the mobile device relative to a cell, and
determine weighting of counter output for use in estimation of a mobility state of the mobile device, the determining comprising comparison of the at least one parameter to at least one threshold.

15. An apparatus for mobility control, the apparatus comprising at least one processor, and at least one memory including computer program code, wherein the at least one memory and the computer program code are configured, with the at least one processor, to
provide information about weighting of a counter output for use in estimation of a mobility state of a mobile device, the information comprising at least one threshold,
obtain information of estimated mobility state of the mobile device, the information being based on at least one parameter determined based on measurements by the mobile device and the at least one threshold, and
take the information of the estimated mobility state into account in mobility control of the mobile device.

16. (canceled)

17. (canceled)

18. (canceled)

19. (canceled)

20. An apparatus according to claim 14, wherein different cells are provided with a different at least one threshold and/or a different at least one predefined weight.

21. (canceled)

22. An apparatus according to claim 14, wherein the measurements comprise measurement of at least one of signal power, signal quality and error rate.

23. An apparatus according to claim 14, wherein the at least one parameter is determined based on difference between measured values of a parameter monitored by the mobile device.

24. An apparatus according to claim 14, comprising a reselection counter or a handover counter.

25. An apparatus according to claim 14, configured to categorise the mobility state of the mobile device based on a weighted counter output.

26-29. (canceled)

30. A method according to claim 2, wherein different cells are provided with a different at least one threshold and/or a different at least one predefined weight.

31. A method according to claim 2, wherein the measurements comprise measurement of at least one of signal power, signal quality and error rate.

32. A method according to claim 2, wherein the at least one parameter is determined by computing the difference between measured values of a parameter monitored by the mobile device.

33. A method according to claim 2, comprising weighting a reselection count or handover count.

34. A method according to claim 2, comprising categorising mobility state of the mobile device based on a weighted counter output.

35. An apparatus according to claim 15, wherein different cells are provided with a different at least one threshold and/or a different at least one predefined weight.

36. An apparatus according to claim 15, wherein the measurements comprise measurement of at least one of signal power, signal quality and error rate.

37. An apparatus according to claim 15, wherein the at least one parameter is determined based on difference between measured values of a parameter monitored by the mobile device.

38. An apparatus according to claim 15, comprising a reselection counter or a handover counter.

39. An apparatus according to claim 15, configured to categorise the mobility state of the mobile device based on a weighted counter output.
